(19) United States
(12) Patent Application Publication
(10) Pub. No.: US 2003/0161452 A1
(43) Pub. Date: Aug. 28, 2003

(54) Telephone correspondent reception system for unavailable subscriber

(76) Inventors: Marc Fournier, Lannion (FR); Regis Corbel, Lannion (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/311,844

(22) PCT Filed: May 31, 2001
(86) PCT No.: PCT/FR01/01701

(30) Foreign Application Priority Data
Jun. 19, 2000 (FR) 00/07779

(51) Int. Cl. H04M 1/64

(52) U.S. Cl. 379/88.22

(57) ABSTRACT

A telephone caller reception system for use by subscribers when they are unavailable. According to the invention said system comprises a data server (11) containing an electronic diary specific to the subscriber, an interface (22,22,23) for providing the subscriber with access to the data server (11) for consulting and updating data, a voice server (12) including a reception service capable, in conjunction with the electronic diary, of composing messages to callers concerning the availability of the subscriber, and means (22,24) for providing a caller with access to the voice server (12). Application to telephone services.

The present invention relates to a telephone caller reception system for use by subscribers when they are unavailable.

A particularly advantageous application of the invention is to the field of telephone services enabling a subscriber to exchange information with callers attempting in vain to contact him when he is unavailable.

At present, callers wishing to contact persons who are unavailable are given information only if a sufficiently pertinent sound message has been recorded beforehand using a telephone answering machine or a voicemail service.

In practice this is often not the case, because recording a message in this way takes too long and is too complicated for the message to be renewed easily and frequently, although that is a precondition for providing pertinent and reliable information that is usable by callers and that is really informative as to exactly how to contact the subscriber. Furthermore, that kind of information cannot be easily varied as a function of caller identity, as this would require a multiplicity of messages, which is hardly a step in the required direction of enhanced responsiveness.

The most sophisticated telephone services offered to subscribers are of the “personal assistant” type and group together basic services such as a mail service, a directory, a diary, call filtering, and call forwarding, with the aim of generating a synergy that simplifies and enhances the use of each function. For example, by combining a mail service with a directory, messages offered to the subscriber can be preceded by the name of the caller which, as well as making the service more user friendly, enables discriminatory searching of the mail service simply by speaking the name of a caller included in the directory.

Those prior art telephone services include:

subscriber location, which combines a plurality of telephone numbers so that the subscriber can be found using a “find me” function, for example “office number, then mobile number, and finally home number”, and

Call Return request, which offers the subscriber the caller's telephone number as conveyed by the network as a Call Return number, so that the caller does not need to enter his number.

Nevertheless, the absence of a real voice service offered to callers and capable of providing them with pertinent information if the subscriber is unavailable makes a very negative contribution to the “answering machine syndrome”, which applies just as much to the above-cited services, although they are touted as being sophisticated.

For want of accurate and reliable information, which is essential if callers are to be helped, and for want of service elements that immediately show the benefit of continuing a call even if the subscriber is unavailable, the caller usually hangs up at the start of a stereotyped recorded announcement.

Accordingly, the technical problem to be solved by the present invention is that of proposing a telephone caller reception system for use by subscribers when they are unavailable which system defines a voice service capable, when the subscriber is unavailable, of providing callers with accurate and reliable information on how to contact him, for example by indicating the time and/or date he will next be available, or even the reason why he is unavailable.

According to the present invention, the solution to the stated technical problem consists in the fact that said system comprises:

a data server containing an electronic diary specific to the subscriber,

an interface for providing the subscriber with access to the data server for consulting and updating data,

a voice server including a reception service capable, in conjunction with the electronic diary, of composing messages to callers concerning the availability of the subscriber, and

means for providing a caller with access to the voice server.

Accordingly, as described in detail below, the subscriber can use his access interface, for example a graphical user interface on a personal computer, to record in his electronic diary in the data server the dates, times and possibly reasons for his unavailability (at a meeting, travelling, etc.). The electronic diary can also be updated vocally if, as provided by the invention, said system enables the subscriber to access the voice server.

If a caller attempts to call the subscriber when he is unavailable, the voice server's reception service composes a message which is reproduced by a voice synthesizer to inform the caller accurately and reliably that at the present date and time the subscriber is not available for a specified reason and will be back at the time indicated in the diary.

The caller then has several options. The voice server can invite him to leave a message for the subscriber. In this case, the system of the invention also includes a voicemail facility.

If, as in one embodiment of the invention, the voice server contains pre-recorded messages deposited by the subscriber, then the caller can listen to one of the pre-recorded messages providing information about the subscriber's present unavailability and/or future availability.

In accordance with the invention, another option is for the data server to include a call forwarding function for transferring a caller's call to a specified telephone number during a specified time interval. This enables the subscriber to forward calls from callers to a number at which he can be contacted. This call forwarding function can further be associated with a call filtering function enabling the subscriber to accept or refuse the calls offered, visually or vocally.

Finally, the invention provides a further option whereby the voice server further includes an appointment service capable, in conjunction with the subscriber's electronic diary, of producing information on the subscriber's appointments with callers. By establishing a dialogue with the service based on voice recognition in natural language, this advantageous feature enables callers to request an appointment with the subscriber, characterized in particular by a date, a time, and a duration, and enables the system to check the subscriber's electronic diary to verify the compatibility of the data relating to the requested appointment with the corresponding time period in the diary and to confirm the chosen appointment or to propose another available time period, if necessary. The subscriber is informed of the appointment on consulting his electronic diary using his interface providing access to the data server.

To enable the information to be varied as a function of caller identity, the invention proposes that the data server also comprise an electronic directory of callers. Clearly, by associating said electronic directory with the reception service and the appointment service, it is possible to personalize messages to callers by providing specific information determined by the subscriber and to reserve some services, for example call forwarding, to specified callers, referred to as priority callers.

In conclusion, the major benefit of the system of the invention is that it improves the service provided when a subscriber is unavailable. This is reflected in particular in a reduced number of Call Returns and in the number of appointments made.

The information provided is much more reliable than the information content of simple voice messages or pre-recorded announcements, as used in the prior art summarized above, because the means for initializing the information made available by the subscriber enable frequent, fast, and simple updating that can be scheduled in advance and in particular is not tied to the network infrastructure.

Also, the handling of the caller is more productive, i.e. informative, than the mere and somewhat infrequent leaving of voice messages since, by making an appointment, for example, the caller can optimally influence the commercial activity of a subscriber who is unavailable.

At the same time, the invention improves on the most sophisticated personal assistant services, which use the diary only as a way to store conventional information reserved for use by the subscriber, as well as web appointment services that make available to the subscriber's clients only a personal computer type interface.

The following description with reference to the accompanying drawings, which are provided by way of non-limiting example, explains in what the invention consists and how it can be put into effect.

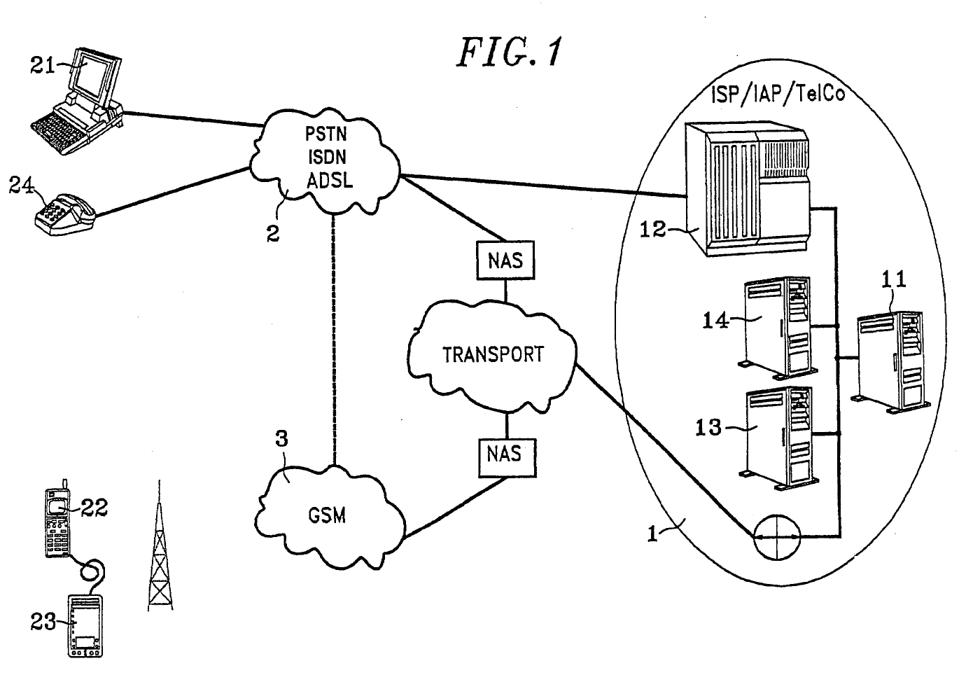

FIG. 1 is a diagram showing one architecture of a telephone reception system of the invention.

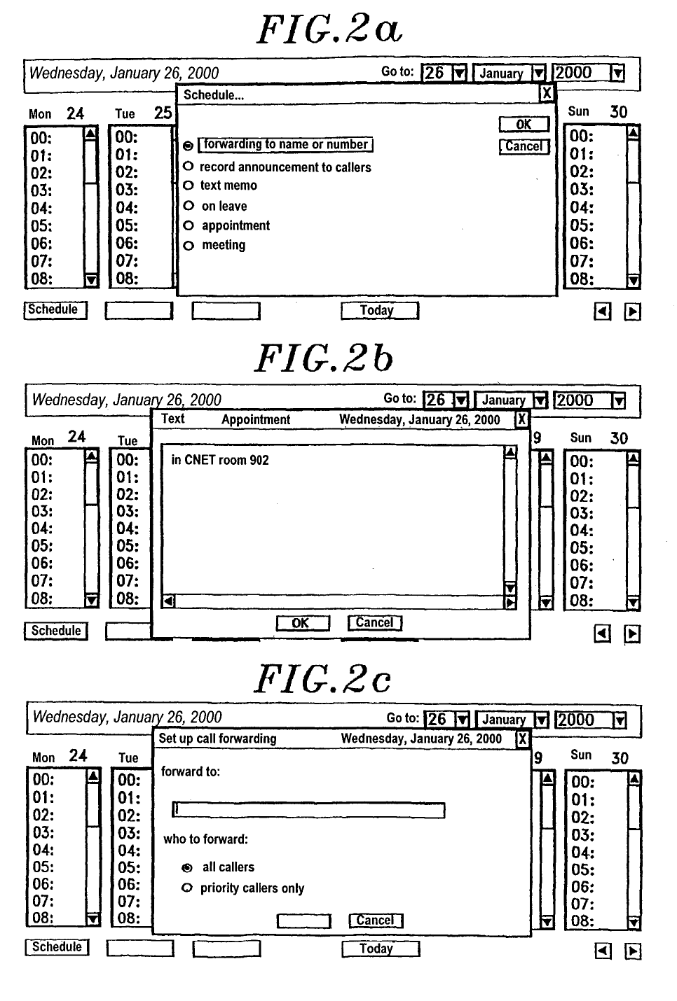

FIGS. 2a, 2b, 2c show screen pages of an interface providing a subscriber with access to the FIG. 1 system.

FIG. 1 shows a telephone caller reception system for use when subscribers are unavailable. The system is based on a network 1 of an Internet service provider or a telecommunications carrier, for example, and comprises a data server 11 and a voice server 12 capable of synthesizing voice from text and of voice recognition independent of the speaker, respectively to communicate information stored in text form and to enable callers to interact with the system, in particular to make an appointment.

In a basic embodiment of the FIG. 1 system, the data server 11 contains an electronic diary specific to the subscriber and the voice server 12 includes a reception service capable, in conjunction with the electronic diary, of composing messages to callers concerning the availability of the subscriber.

In more advanced versions of the telephone reception system of the invention, the voice server 12 also includes an appointment service which acts in conjunction with the electronic diary in the data server 11 to produce information about the subscriber's appointments with callers. Similarly, the data server 11 includes an electronic directory of callers, created with the aim of personalizing the service as a function of the identity of callers.

The voice server 12 of the FIG. 1 system further includes a conventional voicemail system if the appointment service is of no utility in the context of the activity of the subscriber or if a caller does not wish to make an appointment.

The subscriber can access the data server 11 directly via a graphical user interface to consult and update his electronic diary and the directory of callers. For example, the interface is a personal computer 21 connected to a web server 13 of the network 1 via an access telephone network 2, a mobile telephone 22 or a personal assistant 23 connected to a WAP server 14 of the public switched telephone network 1 via the GSM network 3. The subscriber can also manage the data server 11 via the voice server 12 using a software client which is installed on the personal computer 21, is not connected to a web server, but is connected directly to the data server 11, the mobile telephone 22, or a fixed telephone 24. Because of this access to the voice server 12, the subscriber can if necessary consult his voicemail and deposit pre-recorded messages.

Callers can access the voice server 12 directly from a mobile telephone 22 or a fixed telephone 24 and thence access the data server 11 indirectly, either to receive data associated with the availability of the subscriber or to supply data associated with a new appointment.

FIG. 2a shows a reception page on the access interface of the subscriber as it might appear on a personal computer 21. Using a menu, and in conjunction with a calendar indicating days and time periods, it is possible for the subscriber to fill in his electronic diary and schedule his various periods of unavailability, possibly indicating a reason. For example, after selecting Wednesday Jan. 26, 2000 and a time period ending at 10 am, the subscriber has chosen the “Appointment” option from the “Scheduling” menu, which has called up an “Appointment” window onto the screen, as can be seen in FIG. 2b. The subscriber can then show the subject of the meeting; here the meeting in question is taking place “in CNET room 902”.

The following is an example of the dialogue between a caller and the telephone reception system of the invention, assuming that the caller is not on the list of 25 callers for whom a personalized pre-recorded message could have been deposited in the voice server 12.

In response to a call from the caller on January 26 before 10 am, the voice guide of the voice server 12 delivers the message: “Good morning, trying to connect you to <subscriber_name>”. The system then transmits the request from the voice server 12 to the diary in the data server 11, which in turn sends back to the server 12 information to the effect that the subscriber is unavailable until 10 am because he is at a meeting in CNET room 902. This information is communicated to the caller by a voice synthesizer: “I am sorry <subscriber_name> is <at a meeting> in <CNET room 902> until <10 am>. I will tell him you called; if you like, I can take a message for him or make you an appointment with him: to leave a message, please say Message, or to make an appointment, please say Appointment”.

| | |
|---|---|
| Caller: | “I want to make an appointment” |
| Voice guide: | “Very well, who is calling” |
| Caller: | “John Brown” |
| Voice guide: | “Thank you. Which day would you like |
| | to see him?” |
| Caller: | “Next Tuesday” |
| Voice guide: | “At what time?” |
| Caller: | “About 5 p.m., if possible” |
| Voice guide: | “Please wait a moment” |

The appointment request is then sent from the voice server 12 to the electronic diary with data concerning the day and the time (Tuesday, Feb. 1, 2000, 5 p.m.). The data server 11 checks if the subscriber is available on that date and within the time period 5 p.m.-6 p.m. If so, the dialogue with the caller continues in the following manner:

Voice guide: “I have made a note that <John Brown> would like an appointment on <Tuesday Feb. 1, 2000>from <5 p.m.>to <6 p.m.>; is that all right?”

| | |
|---|---|
| Caller: | “Yes, quite all right” |
| Voice guide: | “Thank you. Goodbye” |

The new appointment is then written permanently into the electronic diary of the subscriber, who is informed of it the next time he consults his diary. As can be seen in FIG. 2a, the subscriber has access on his graphical user interface to a call forwarding function (first menu option) for transferring a call from a caller to a specified telephone number or to a specified person, whose name is translated into a telephone number by the electronic directory, for a specified time period. For this it suffices to fill in the FIG. 2c transfer window. It will be noted that this function can be offered to all callers or to a few priority callers, only.

The second option from the FIG. 2a menu sends callers a pre-recorded message deposited by the subscriber of the type “I am not available at this number on Wednesdays”. The function for making the necessary recording is offered to the subscriber when he accesses the voice server 12.

The subscriber can use the system to deal with events generated by a telephone network, for example if the number is busy or if there is no answer. The system can also be active at all times. In this case, a caller is put on hold while the call is offered to the subscriber. If the call is accepted, the caller and the subscriber are connected in the normal way and the telephone reception system is suspended. If the subscriber declines to answer the caller's call, the system is started up in a similar manner to that which applies when the subscriber is unavailable. If the subscriber's electronic diary is empty when a call is refused, a generic unavailability message (“Sorry, I am not available”) is sent to the caller.

1. A telephone caller reception system for use by subscribers when they are unavailable, which system is characterized in that it comprises:
a data server (11) containing an electronic diary specific to the subscriber,
an interface (22,22,23) for providing the subscriber with access to the data server (11) for consulting and updating data,
a voice server (12) including a reception service capable, in conjunction with the electronic diary, of composing messages to callers concerning the availability of the subscriber, and
means (22,24) for providing a caller with access to the voice server (12).

2. A telephone reception system according to claim 1, characterized in that said voice server (12) also includes an appointment service capable, in conjunction with the electronic diary of the subscriber, of providing information on the subscriber's appointments with callers.

3. A telephone reception system according to either claim 1 or claim 2, characterized in that it comprises means (21,22,24) for providing the subscriber with access to the voice server (12).

4. A telephone reception system according to claim 3, characterized in that the voice server (12) contains pre-recorded messages deposited by the subscriber.

5. A telephone reception system according to any one of claims 1 to 4, characterized in that the data server (11) also includes an electronic directory of callers.

6. A telephone reception system according to any one of claims 1 to 5, characterized in that said data server (11) includes a call forwarding function for transferring a caller's call to a specified telephone number during a specified time interval.

7. A telephone reception system according to any one of claims 1 to 6, characterized in that it also provides a voicemail facility.

8. A telephone reception system according to any one of claims 1 to 7, characterized in that it is activated when the subscriber is busy or does not answer.

9. A telephone reception system according to claim 8, characterized in that it is also activated if the subscriber declines to answer a caller's call.

10. A telephone reception system according to claim 9, characterized in that a generic unavailability message is sent if the electronic diary of the subscriber is empty at the time a call is refused.
